(19) United States
(12) Patent Application Publication
(10) Pub. No.: US 2026/0004473 A1
(43) Pub. Date: Jan. 1, 2026

(54) SYSTEMS AND METHODS FOR PRODUCING A DISPLAY ITEM

(71) Applicant: Matthews International Corporation, Pittsburgh, PA (US)

(72) Inventors: Michael EDDY, Pittsburgh, PA (US); Kevin COLDREN, Pittsburgh, PA (US)

(21) Appl. No.: 19/254,224

(22) Filed: Jun. 30, 2025

Related U.S. Application Data
(60) Provisional application No. 63/666,314, filed on Jul. 1, 2024.

(51) Int. Cl. G06T 11/00

(52) U.S. Cl. CPC G06T 11/00

(57) ABSTRACT

A method is provided for producing a display item. Display item parameter data and user input data are received. A design prompt is generated based on the data. User uploads such as photos and other documents are also received. A personalized display item design is generated based on the design prompt and user uploads. The generated design is refined based on pre-defined system constraints. User feedback is received on the refined design. The display item design is further refined based on the user feedback. The design is refined iteratively based on the user's feedback as well as the pre-defined system constraints until the user approves the design. The display item is manufactured based on the display item design approved by the user.

### CROSS-REFERENCE TO RELATED APPLICATIONS

This application claims priority to U.S. Provisional Application No. 63/666,314, filed Jul. 1, 2024, which is incorporated herein by reference in its entirety.

### FIELD

The subject matter described herein relates to systems and methods for producing display items.

### BACKGROUND

A display item, whether it be a personal item such as a grave marker (e.g., a bronze attachment to a grave stone, an engraving on a granite grave stone) or a public installation such as a historic site plaque (e.g., a metal casted or engraved sign inside or outside of a site of historic significance), enables the communication of information, such as the conveyance of history from one generation to the next. A display item should clearly provide information in a durable form, typically a form that will last for many years. Frequently, display items such as memorialization products are designed during a painful time for the designer, such as upon a recent death of a friend or family member. While it is important for a fitting display item to be designed and produced, automation of aspects of that process can ease the burden on the item designer.

### SUMMARY

A method is provided for producing a display item. Display item parameter data and user input data are received. A design prompt is generated based on the data. User uploads such as photos and other documents are also received. A personalized display item design is generated based on the design prompt and user uploads. The generated design is refined based on pre-defined system constraints. User feedback is received on the refined design. The display item design is further refined based on the user feedback. The design is refined iteratively based on the user's feedback as well as the pre-defined system constraints until the user approves the design. The display item is manufactured based on the display item design approved by the user.

### DESCRIPTION OF THE DRAWINGS

FIG. 1 is a diagram depicting a method for producing a display item.

FIG. 2 is a diagram depicting an example display item generated via the process of FIG. 1.

FIG. 3 is a diagram depicting further details of a design module.

FIG. 4 is an exemplary process flow diagram illustrating a method for producing a commemorative item to be placed in a cemetery.

FIG. 5 is a diagram illustrating details of an exemplary design module.

FIG. 6 is an exemplary process flow diagram illustrating a method for producing a display item.

FIGS. 7A, 7B, and 7C depict example systems for implementing the approaches described herein for producing a display item.

### DETAILED DESCRIPTION

Systems and methods herein provide mechanisms for automating the process for display item design. The systems and methods described herein can provide mechanisms for producing both simple and complex (e.g., designs that include one or more of text, photographs, and automated image designs) display item designs in an automated or semi-automated fashion. Display items described herein may include a plurality of products that memorialize or are dedicated to a person, object, entity, event, milestone, or occasion such as memorials, monuments, markers, plaques, panels, signs, tablets, commemorative items, or burial items. They may also include other objects designed to communicate information in text, symbol, or picture form, such as business signs or advertisements. The display items may be made of various materials such as bronze, aluminum, steel, granite, stone, wood, glass, plastic, foam, ceramic, porcelain, or high density urethane (“HDU”).

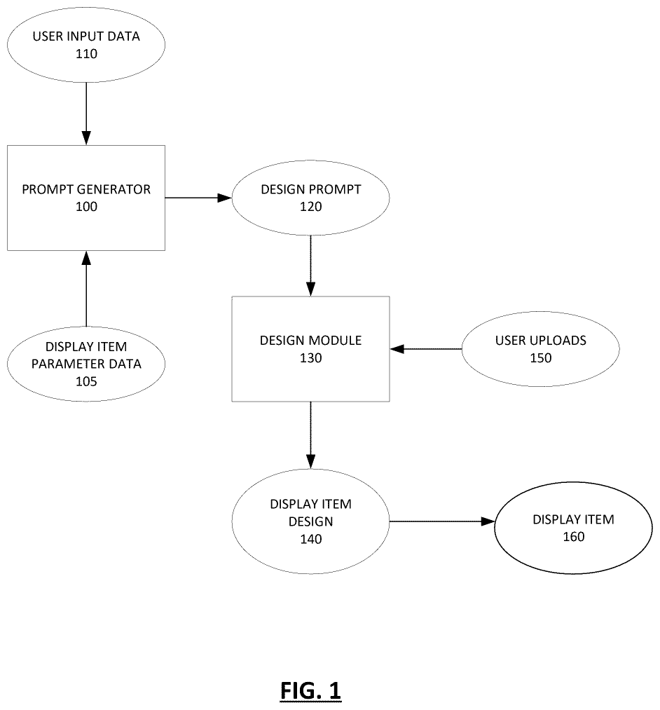

FIG. 1 is a diagram depicting a system for designing display items. A prompt generator 100 receives display item parameter data 105 and user input data 110. The display item parameter data 105 may include a set of specifications regarding the display item that the user wants. That data 105 may include specification of several components, such as a type of display item (a grave marker, an urn, a historic site plaque); and its size, shape, material, and color. The user input data 110 may include data associated with customizations of the display item. For example, the user input data 110 may include text to be displayed on the display item and its positioning on the item. The input data may identify any decorative item to be displayed and its positioning on the item. That decorative item specification may be specified particularly (e.g., selection of an image from a library) or in words (e.g., “a farm scene,” “a man fishing”). The user input data 110 may further include an indication of a theme for the design. The user input 110 may be received in various ways such as by selection of options on a graphical user interface (“GUI”), verbally, as textual input, through an interview, through responses to prompts, or through collection of information from a relevant social media profile (e.g., scraping a Facebook page associated with a person being memorialized).

The display item parameter data 105 and the user input data 110 are provided to a prompt generator 100 that is configured to generate a design prompt 120 that is optimized for submission to a design module 130. The design module 130 may take a variety of forms, such as an automated image generation engine that uses a machine learning (e.g., artificial intelligence) module to generate image output that can be used as a display item design 140. In the example of FIG. 1, the prompt generator 100 processes the display item parameter data 105 and the user input data 110 to generate the design prompt 120. The design prompt 120 contains text (e.g., a person's name, data of birth, date of death, an inspirational saying; a description of a historical event) and/or images (e.g., an image file associated with a decorative item or a theme selected by a user) that are provided as a stimulus for the design module 130. The design module 130 may further receive additional uploaded content, such as user uploads 150, to use in generating the display item design 140, such as photos, the text of an obituary, or other documentary uploads.

In some examples, the prompt generator 100 optimizes that input 105, 110 into a design prompt 120. In one embodiment, the prompt generator 100 can comprise a large language model (“LLM”) that is trained to analyze the input 105, 110 and output a design prompt 120 that fully captures the user's desired design specifications. The design prompt 120 can take a variety of forms, such as a set of technical instructions that captures the user input 110, that is in an appropriate format that can be understood by the design module 130. The design module 130 receives the design prompt 120, as well as user uploads 150. In an embodiment, the design module 130 can be a generative Artificial Intelligence (“AI”) model that has been trained on a vast amount of display items' designs in order to output a design per user specifications. The user uploads 150 can be a plurality of files such as photo, obituary, or other documents relating to the subject of the display item. The design module 130 generates a display item design 140 that is personalized to the user input 110 and the user uploads 150. The display item design 140 may also directly incorporate an image from the user uploads 150. In an embodiment, the display item design 140 can be a 3D rendering of the final display item 160 that the user can view. In another embodiment, the display item design 140 can be a technical blueprint that is in an appropriate format for direct physical production of the display item 160.

The display item 160 is a physical embodiment of the display item design 140. The display item design 140 may be transformed into the display item 160 through several methods, including 3D printing, engraving, lasering, and other means of craftsmanship. For example, the display item design 140 can be a digital 3D model, which is provided to a 3D printer to produce a mold for a bronze display item 160. In another example, the display item design 140 can be a laser engraving design, which is provided to a laser engraving machine to engrave on a piece of granite to create the display item 160.

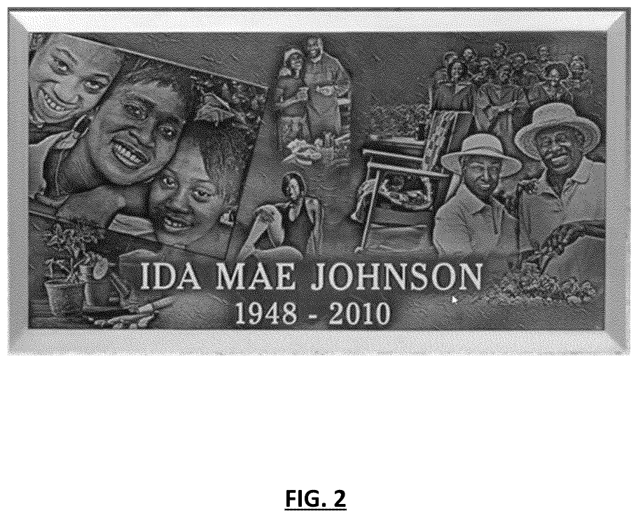

FIG. 2 depicts an example display item generated via the process of FIG. 1. The exemplary item is a bronze grave marker that has been personalized to the text and pictures provided by the user. In the example, display item parameter data 105 may have included information about parameters of the memorial (e.g., bronze type, a desired size). User input data 110 may have included text to appear on the memorial (e.g., name, dates of birth and death). User uploads 150 may have included a number of pictures. A prompt generator 100 used the display item parameter data 105 and the user input data 110 to generate a design prompt 120 that is used to instruct the design module 130 to generate the display item design 140 that resulted in the display item 160 shown in FIG. 2. In some examples, the user uploads 150 (e.g., the pictures) are provided to the design module 130 as part of the design prompt 120, while in other examples, the user uploads 150 are provided to the design module 130 as separate inputs.

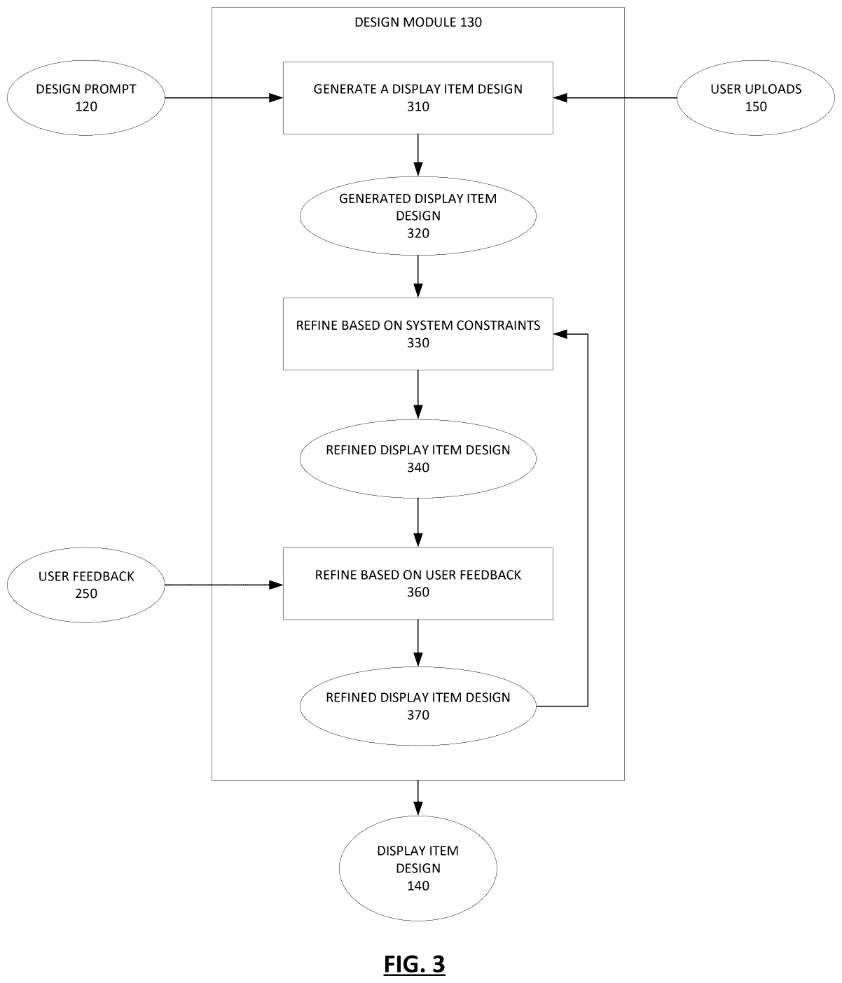

FIG. 3 illustrates further details of the design module 130. The design module 130 receives the design prompt 120 and user uploads 150. At 310, the design module 130 generates a display item design 320. At 330, the display item design 320 is refined based on pre-defined system constraints to generate a refined display item design 340. The pre-defined system constraints may relate to manufacturability and propriety of the design. The manufacturability constraints may relate to physical parameters like size, shape, color, spacing, drill points, and style. For example, if a user wants to design a monument and chooses to display certain text on the monument, one of the pre-defined manufacturability constraints may relate to the relative size of display text possible with respect to the size of the chosen monument. Similarly, the pre-defined propriety constraints may relate to improper use of trademarked or copyrighted content, compliance with relevant laws and regulations, and profanity. For example, if the display text input by the user contains potentially trademark infringing content, the design module 130 can flag that to the user and provide alternative text the user can use, or other steps the user can take to get approval from the trademark owner for that use. In an embodiment, the design module 130 can recognize the pre-defined system constraints because it is trained on existing display item designs that comply with specific manufacturability and propriety guidelines. In another example, the design module 130 is programmed with specific pre-defined rules relating to these guidelines.

In an embodiment, the user can override the pre-defined system constraints at 330. For example, the user is designing a display item design 140 for an architectural plaque that is dedicated to an entity, and is to be displayed within the entity's premises. The pre-defined system constraints may include a profanity filter, so the design module 130 will flag to the user any content containing profanity in the design prompt 120 or the user uploads 150. However, the content may be acceptable to the user and the entity the plaque is dedicated to, in which case, the user (or another person in the process with sufficient authority in the process, such as an employee at the organization that provides the system for designing a display item or the organization that manufactures the display item) may override the pre-defined system constraints against profanity by instructing the design module 130 to include the flagged content in the refined display item design 340.

At 360, the design module 130 receives user feedback 350 on the refined display item design 340. The user feedback 350 can be received through textual input or direct manipulation. In one embodiment, the user can provide textual input describing the changes that the user wants to make to the design. For example, if the user is designing a commemorative item in the form of a plaque, the user can provide textual input such as “change the backdrop to mountains” or “add a haiku to the bottom left about how beautiful life is.” In another embodiment, the user can directly manipulate the refined display item design 340 via an interactive GUI. For example, the user can drag and drop elements of the design in different positions, edit text, resize elements, or change any images. At 360, the design module 130 further refines the refined display item design 340 based on the user feedback 350 to generate a refined display item design 370. The refined display item design 370 is further refined based on system constraints at 330. Steps 330 to 370 are iterated until the user approves the display item design. The design module 130 outputs the display item design 140, which has been approved by the user.

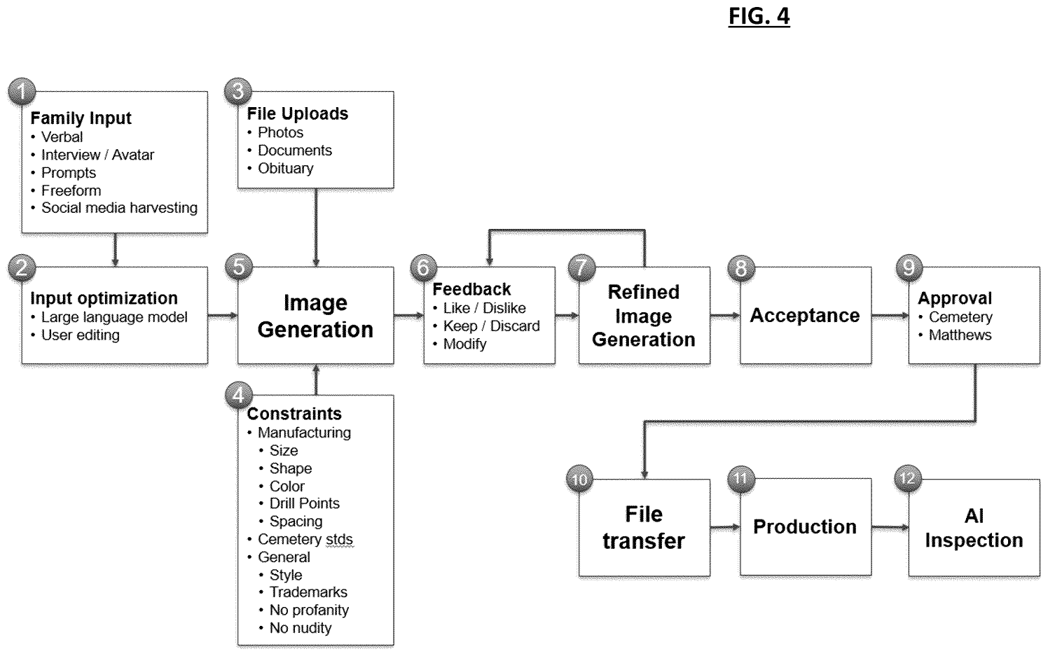

FIG. 4 is an exemplary process flow diagram illustrating a method for producing a display item. In this example, the display item is a commemorative item that is designed by a family to be placed in a particular cemetery. At 1, the family input is accessed relating to the specifications and design of the commemorative item. The family input can be accessed verbally, through an interview via a digital avatar, through prompts, in freeform, or through social media harvesting. At 2, the family input is provided to a Large Language Model (“LLM”) that is configured to optimize the family input into a design prompt that captures the family's intended design for the commemorative item. The design prompt output by the LLM may be edited by the family. The design prompt is provided to an image generation model at 5, which is configured to generate a commemorative item design, in the form of an image, that is personalized to the design prompt. The image generation model also receives additional file uploads from the family at 3, to use in generating the design, such as photos, the text of an obituary or other documentary uploads.

The image generation model may have pre-defined system constraints relating to manufacturability, standards set by the particular cemetery, and propriety of the design. For example, the constraints relating to manufacturability may include physical parameters such as size, shape, color, drill points, and spacing. The constraints relating to standards set by the particular cemetery may include color, shape, and size. The constraints relating to propriety may include style, use of trademarked content, profanity, and nudity. The image generation model generates a design for the commemorative item that is personalized to the design prompt and file uploads, and that complies with the pre-defined system constraints.

The commemorative item design is provided to the family for feedback. At 6, the family can provide feedback as to whether they like or dislike the design, whether they want to keep or discard the design, and whether they want to modify any aspects of the design. The family's feedback is provided to a refined image generation model at 7, which is configured to refine the generated commemorative item design based on the family's feedback. The family can continue to provide feedback such that the refined image generation model iteratively refines the generated commemorative item design until the family provides acceptance of the design at 8. Upon the family's acceptance, the commemorative item design goes through an approval process at 9. In this example, the approval process at 9 includes approval by the cemetery where the commemorative item is to placed, and by the commemorative item manufacturer, Matthews.

In this example, the commemorative item design is in a file format that is directly compatible with the production process and machinery. At 10, the commemorative item design is transferred to the production module at 11. The production module produces a commemorative item that is a physical reproduction of the commemorative item design. For example, the commemorative item design may be a digital laser engraving design, which is directly sent to an engraving machine (e.g., a laser engraving machine, a water engraving machine), that engraves the design of the size, shape, and color chosen by the family onto a substrate also chosen by the family (e.g. aluminum plaque, granite stone). In other examples, the commemorative item design takes the form of a three-dimensional drawing file that can be used to produce a mold for forming the commemorative item. In some examples, such a mold is formed by a router, which can form a mold at a high level of detail. In other examples, the mold is formed using three-dimensional printing technology. In some examples, a tool selection (e.g., router versus three-dimensional printing) is made based on the level of detail indicated by the commemorative item design (e.g., a more precise router-tool is selected when a resolution associated with the commemorative item design is greater than a threshold).

At 12, the commemorative item is quality checked by an AI module. For example, the AI module may visually compare the commemorative item to the commemorative item design to ensure precise reproduction of the design. In another example, the AI module may superficially inspect the commemorative item for any physical defects.

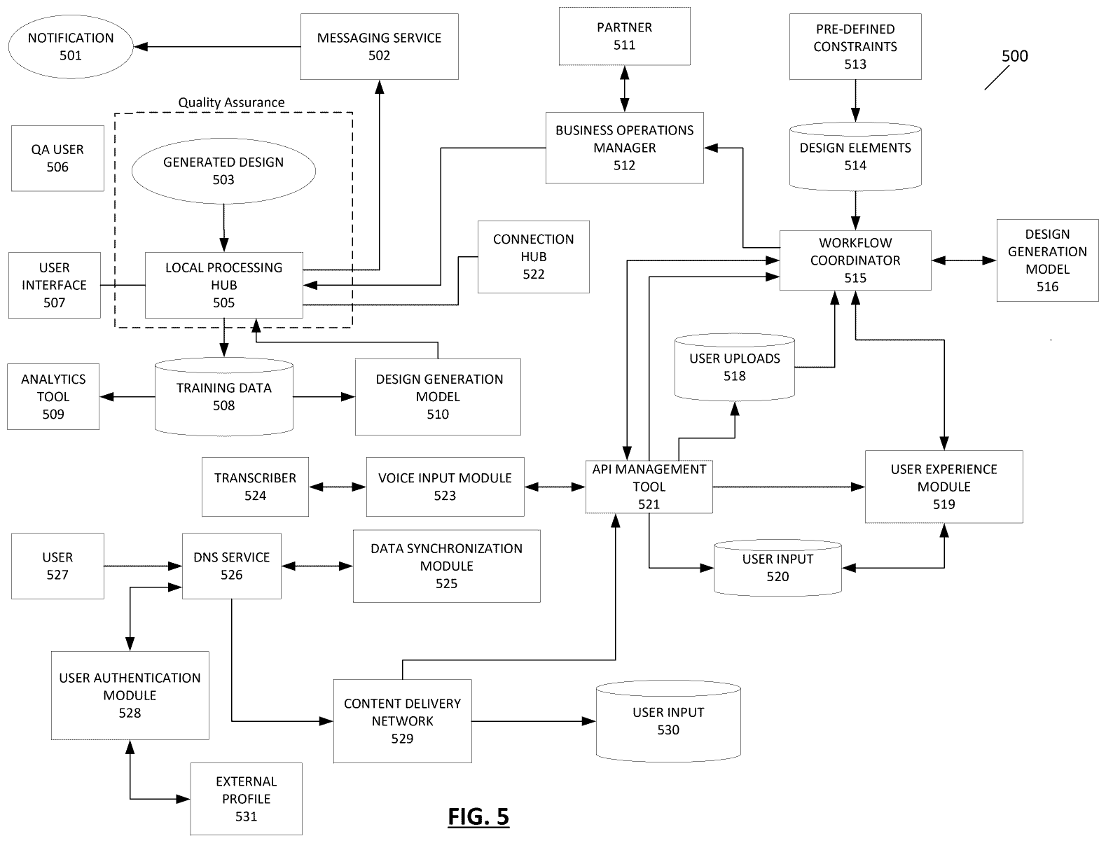

FIG. 5 is a diagram illustrating details of an exemplary design module 500, that is hosted on a website. When user 527 requests access to the design module, the user is routed to the appropriate server via Domain Name System (“DNS”) Service 526. DNS Service 526 translates the website's domain name into its Internet Protocol (“IP”) address, thus routing the user 527 to the appropriate address. Before being routed, user 527's identity is authenticated at user authentication module 528. In this exemplary figure, the user authentication module 528 allows user 527 to authenticate their identity by linking an external profile 531, such as a social media profile, that already has the user's credentials.

The DNS Service 526 also interacts with data synchronization module 525, which allows the design module 500 to access the precise data or service required from multiple databases.

Once user 527 is authenticated, the user is directed to a content delivery network 529. The content delivery network 529 delivers a user interface that allows user 527 to interact with the design module 500. For example, the user interface may be a webpage that allows the user 527 to request a particular design, and input various design parameters for the display item, input text to be displayed on the display item, or upload images to be displayed on the display item. The user's input is also received and stored at user input 530 database.

The user's input is sent to Application Programming Interface (“API”) management tool 521, which acts as the entry point for the user's requests and routes the requests to the appropriate services. Any voice input from user 527 is sent to voice input module 523, which uses transcriber 524 to convert the voice input into text. This voice-to-text input, along with any other input that user 527 entered into the user interface, is received and stored at user input 520 database. Any user data uploads, such as images, are received and stored at user uploads 518 database. The API management tool 521 is also integrated with user experience module 519, which is configured to interact with the user input 520 database to efficiently store and retrieve data as required by the design module 500.

The API management tool 521 sends user 527's input and uploads to workflow coordinator 515. Workflow coordinator 515 coordinates the overall design generation process. In addition to user input, it also has access to design elements 514 database, which allows for searching of relevant design elements, such as data, text, and images, related to the display item design that user 527 wants. The design elements 514 database is restricted by pre-defined constraints 513, which are pre-defined rules that the display item design must adhere to. For example, even if the user instructs the design module 500 to use copyrighted content, the pre-defined constraints 513 may restrict use of such content if the user is not authorized to use it. After receiving the user's input, the workflow coordinator 515 utilizes the design elements 514 database to search for appropriate design elements that comply with the pre-defined constraints 513. The workflow coordinator 515 provides these design elements and the user input to a pre-trained design generation model 516, that is configured to generate a personalized display item design based on the design elements and user input.

The design generation model 516 generates a display item design, and sends it to the workflow coordinator 515. The workflow coordinator 515 sends the generated design and related data about the design to business operations manager 512. The business operations manager 512 manages related business operations such as production of the display item that is designed. The business operations manager 512 sends the design and related data to partner 511, who may provide feedback on the design. For example, partner 511 may include a display item manufacturer who provides feedback as to whether the generated design is compatible with the manufacturer's machinery capabilities.

The business operations manager 512 also sends the generated design and related data to a local processing hub 505, which is configured to perform a quality assurance function by analyzing the generated design as well as storing the designs for training other image generation models. The local processing hub 505 sends the generated design and related data to a training data 508 database. The training data 508 database further sends the generated design and related data to analytics tool 509, which is configured to analyze the generated design and its related data to provide insights into the design process. For example, the analytics tool 509 may provide visual analytics summarizing whether and how each component of the user's input was incorporated into the design, how many times the design was refined to comply with the user's feedback and the pre-defined constraints, and which design elements were used in the design. The training data 508 database also functions as a storage space for the generated designs, which are used to train other design generation models 510.

The local processing hub 505 is integrated with a user interface 507, which allows a user to view the generated design. The local processing hub 505 is also integrated with a messaging service 502. When the local processing hub 505 receives a generated design from the business operations manager 512, it triggers the messaging service 502 to send a notification 501 to the user that their design is ready for viewing.

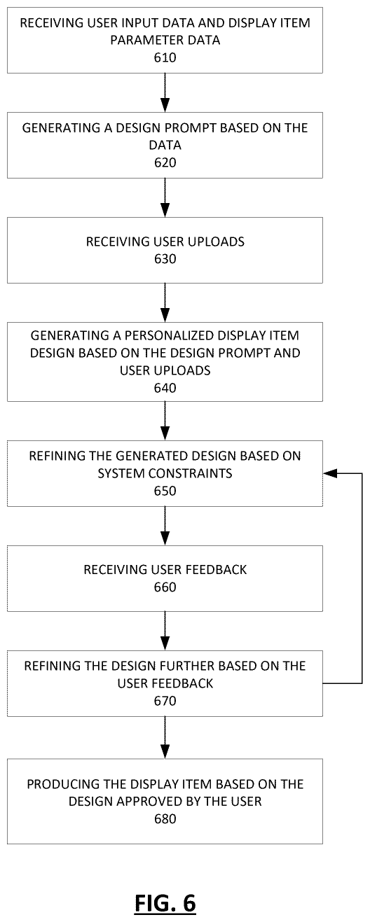

FIG. 6 is an exemplary process flow diagram illustrating a method for producing a display item that is personalized to specifications provided by a user. At 610, user input data and display item parameter data is received. At 620, a design prompt is generated based on the data. At 630, user uploads such as photos and other documents are received. At 640, a personalized display item design is generated based on the design prompt and user uploads. At 650, the generated design is refined based on pre-defined system constraints. At 660, user feedback is received on the refined design from 650. At 670, the display item design is further refined based on the user feedback received at 660. Steps 650 to 670 are iterated until the user approves the design. At 680, the display item is manufactured based on the display item design approved by the user.

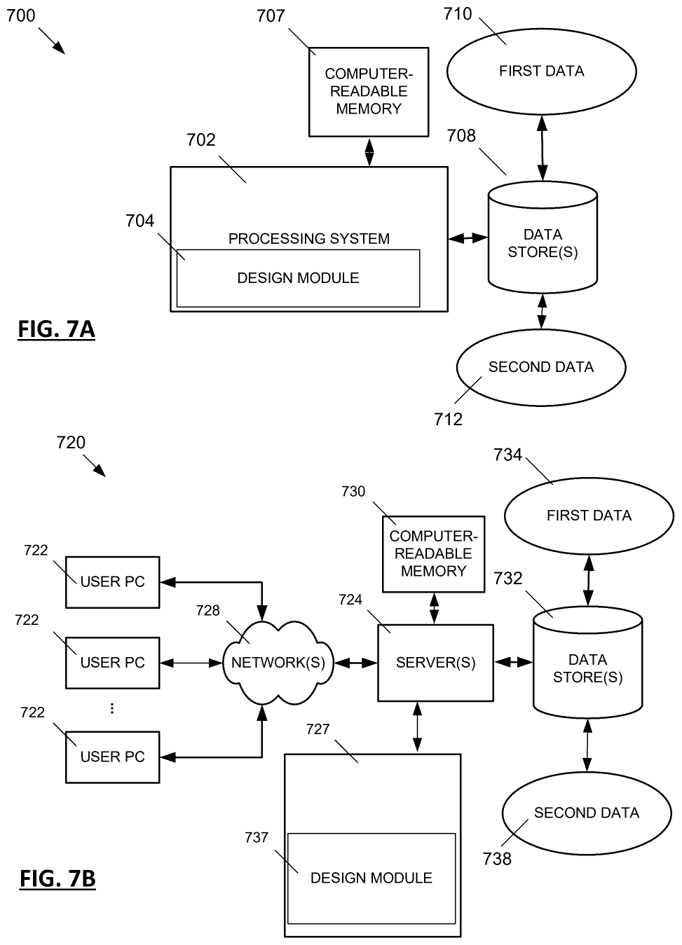

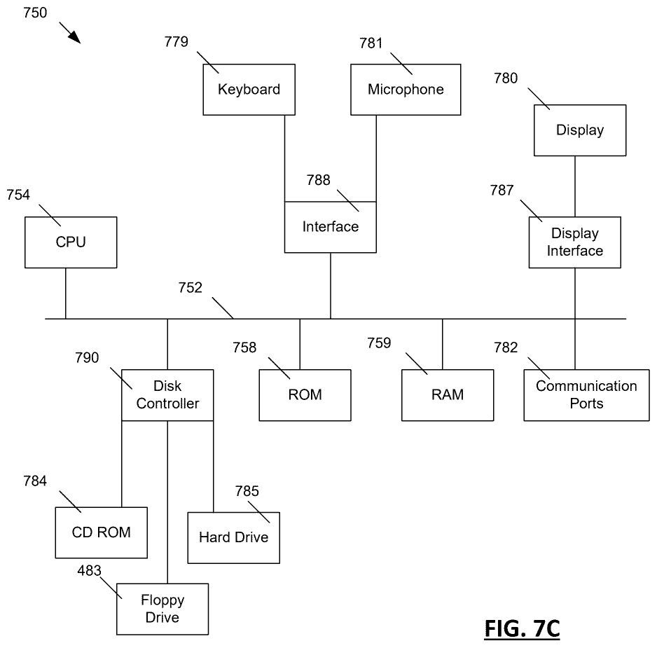

FIGS. 7A, 7B, and 7C depict example systems for implementing the approaches described herein for designing display items. For example, FIG. 7A depicts an exemplary system 700 that includes a standalone computer architecture where a processing system 702 (e.g., one or more computer processors located in a given computer or in multiple computers that may be separate and distinct from one another) includes a design module 704 being executed on the processing system 702. The processing system 702 has access to a computer-readable memory 707 in addition to one or more data stores 708. The one or more data stores 708 may include a first data 710 as well as a second data 712. The processing system 702 may be a distributed parallel computing environment, which may be used to handle very large-scale data sets.

FIG. 7B depicts a system 720 that includes a client-server architecture. One or more user PCs 722 access one or more servers 724 running a design module 737 on a processing system 727 via one or more networks 728. The one or more servers 724 may access a computer-readable memory 730 as well as one or more data stores 732. The one or more data stores 732 may include a first data 734 as well as a second data 738.

FIG. 7C shows a block diagram of exemplary hardware for a standalone computer architecture 750, such as the architecture depicted in FIG. 7A that may be used to include and/or implement the program instructions of system embodiments of the present disclosure. A bus 752 may serve as the information highway interconnecting the other illustrated components of the hardware. A processing system 754 labeled CPU (central processing unit) (e.g., one or more computer processors at a given computer or at multiple computers), may perform calculations and logic operations required to execute a program. A non-transitory processor-readable storage medium, such as read only memory (ROM) 758 and random access memory (RAM) 759, may be in communication with the processing system 754 and may include one or more programming instructions for designing display items. Optionally, program instructions may be stored on a non-transitory computer-readable storage medium such as a magnetic disk, optical disk, recordable memory device, flash memory, or other physical storage medium.

In FIGS. 7A, 7B, and 7C, computer readable memories 707, 730, 758, 759 or data stores 708, 732, 783, 784, 788 may include one or more data structures for storing and associating various data used in the example systems for designing display items. For example, a data structure stored in any of the aforementioned locations may be used to store data from XML files, initial parameters, and/or data for other variables described herein. A disk controller 790 interfaces one or more optional disk drives to the system bus 752. These disk drives may be external or internal floppy disk drives such as 783, external or internal CD-ROM, CD-R, CD-RW or DVD drives such as 784, or external or internal hard drives 785. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 790, the ROM 758 and/or the RAM 759. The processor 754 may access one or more components as required.

A display interface 787 may permit information from the bus 752 to be displayed on a display 780 in audio, graphic, or alphanumeric format. Communication with external devices may optionally occur using various communication ports 782.

In addition to these computer-type components, the hardware may also include data input devices, such as a keyboard 779, or other input device 781, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A computer-implemented method comprising:
receiving display item parameter data and user input data;
generating a design prompt based on the data;
receiving user uploads;
generating a personalized display item design based on the design prompt and user uploads;
refining the generated design based on system constraints;
receiving user feedback;
refining the design further based on the user feedback; and
manufacturing a display item based on the design approved by the user.

2. The computer-implemented method of claim 1, wherein the display item parameter data comprises of specifications regarding the display item such as a type of display item, size, shape, material, and color.

3. The computer-implemented method of claim 1, wherein the user input data comprises of data associated with customizations of the display item such as text or decorative items to be displayed, their positioning on the item, and a theme for the item.

4. The computer-implemented method of claim 1, wherein the display item parameter data and user input data may be received in various ways such as through a graphical user interface (“GUI”), verbally, as textual input, through an interview, through responses to prompts, and through a relevant social media profile.

5. The computer-implemented method of claim 1, wherein the design prompt is optimized for submission to a design generator.

6. The computer-implemented method of claim 1, wherein the user uploads comprise of uploads relevant to the subject matter of the display item such as images, documents, and text from an obituary.

7. The computer-implemented method of claim 1, wherein the system constraints comprise of pre-defined constraints related to manufacturability and propriety of the design.

8. The computer-implemented method of claim 7, wherein the manufacturability constraints comprise of physical parameters like size, shape, color, spacing, drill points, and style.

9. The computer-implemented method of claim 7, wherein the propriety constraints comprise of improper use of trademarked or copyrighted content, compliance with relevant laws and regulations, and profanity.

10. The computer-implemented method of claim 1, wherein the system constraints comprise of pre-defined rules set by the display item's intended display location.

11. The computer-implemented method of claim 1, wherein the user can override the system constraints.

12. The computer-implemented method of claim 1, wherein the user feedback can be received through textual input or direct manipulation of the display item design.

13. The computer-implemented method of claim 1, wherein the user feedback indicates that the user approves the design.

14. The computer-implemented method of claim 1, wherein the display item design is iteratively refined based on the system constraints and user feedback until the user approves the design.

15. The computer-implemented method of claim 1, wherein the display item design is in a file format that is directly compatible with production process and machinery used to produce the display item.

16. The computer-implemented method of claim 15, wherein the display item design is a three-dimensional drawing file that is directly used to produce display the display item using three-dimensional printing technology.

17. The computer-implemented method of claim 1, wherein the display item is a physical production of the display item design.

18. The computer-implemented method of claim 1, wherein the display item is a product that is dedicated to a person, object, entity, event, milestone, or occasion.

19. The computer-implemented method of claim 1, wherein the display item comprises of a memorial, monument, marker, plaque, panel, sign, tablet, commemorative item, or burial item.

20. The computer-implemented method of claim 1, wherein the display item is made on a substrate comprising of bronze, aluminum, steel, granite, stone, wood, glass, plastic, foam, ceramic, porcelain, or high density urethane (“HDU”).

21. The computer-implemented method of claim 1, wherein a type of display item and an appropriate substrate are automatically selected based on the display item design.

22. A computer-implemented method comprising:
receiving display item parameter data and user input data;
generating a design prompt based on the data;
receiving user uploads;
generating a personalized display item design based on the design prompt and user uploads;
refining the generated design based on system constraints;
receiving user feedback;
refining the design further based on the user feedback;
manufacturing a display item based on the design approved by the user; and
performing a quality check on the display item.

23. The computer-implemented method of claim 22 wherein the quality check comprises of a visual inspection of the display item.

24. A system comprising:
one or more data processors;
a computer-readable medium encoded with instructions for commanding the one or more data processors to execute steps of a process, the steps including:
receiving display item parameter data and user input data;
generating a design prompt based on the data;
receiving user uploads;
generating a personalized display item design based on the design prompt and user uploads;
refining the generated design based on system constraints;
receiving user feedback;
refining the design further based on the user feedback; and
manufacturing the display item based on the design approved by the user.
